(19) United States
(12) Patent Application Publication
(10) Pub. No.: US 2024/0307981 A1
(43) Pub. Date: Sep. 19, 2024

(54) TOOL HOLDER

(71) Applicant: Kennametal Inc., Latrobe, PA (US)

(72) Inventors: Alexander Kroedel, Fuerth (DE); Iranna Shidrameshetra, Bangalore (IN)

(21) Appl. No.: 18/599,356

(22) Filed: Mar. 8, 2024

(30) Foreign Application Priority Data
Mar. 13, 2023 (IN) 202341016619

(51) Int. Cl. B23C 5/28

(52) U.S. Cl. CPC B23C 5/28; B23C 2210/02

(57) ABSTRACT

A tool holder for rotary cutting tools is described. The tool holder comprises an axis of rotation, a body having a receptacle for the rotary cutting tool, the receptacle extending coaxially with the axis of rotation, and at least one coolant channel terminating in an opening and adapted to conduct coolant to the rotary cutting tool via the opening. The coolant channel extends through an axial protrusion and the tool holder has an adjusting mechanism which is adjustable between a first position, in which the opening is at a first radial distance from the axis of rotation, and a second position, in which the opening is at a second, different radial distance from the axis of rotation, the axial protrusion being elastically deflected in the second position relative to the first position by the adjusting mechanism.

### RELATED APPLICATION DATA

This application claims priority under 35 U.S.C. § 119 to Indian Patent Application No. 202341016619, which was filed on Mar. 13, 2023 and is incorporated by reference herein in its entirety.

### FIELD

The invention relates to a tool holder for rotary cutting tools, comprising an axis of rotation, a body having a receptacle for the rotary cutting tool, the receptacle extending coaxially with the axis of rotation, and at least one coolant channel terminating in an opening and adapted to conduct coolant to the rotary cutting tool via the opening.

### BACKGROUND

Such tool holders are known from the prior art. When delivering coolant through the face of a tool holder, the coolant is accelerated in a radial direction away from the cutting edge of the rotary cutting tool due to centrifugal effects. Especially if tools with different lengths or different cutting speeds are to be used in the same tool holder, the nozzle formed by the opening of the coolant channel can only be optimized for one specific combination of length and cutting speed.

The object of the invention is to provide a tool holder for rotary cutting tools which is adapted to supply coolant in an effective way to the rotary cutting tool over a wide range of cutting speeds and tool lengths.

### SUMMARY

In order to achieve this object, the invention provides a tool holder for rotary cutting tools, comprising an axis of rotation, a body having a receptacle for the rotary cutting tool, the receptacle extending coaxially with the axis of rotation, and at least one coolant channel terminating in an opening and adapted to conduct coolant to the rotary cutting tool via the opening. The coolant channel extends through an axial protrusion and the tool holder has an adjusting mechanism which is adjustable between a first position, in which the opening is at a first radial distance from the axis of rotation, and a second position, in which the opening is at a second, different radial distance from the axis of rotation, the axial protrusion being elastically deflected in the second position relative to the first position by the adjusting mechanism.

In this way, the adjusting mechanism allows for changing the orientation of the nozzle formed by the opening of the coolant channel and thus adapting the direction of the coolant jet to different cutting speeds and tool lengths to improve the cooling efficiency.

In one embodiment of the invention, the protrusion has an axial length of at least 4 mm, in particular of at least 9 mm. Hereby the protrusion is long enough to be elastically deflected by the adjusting mechanism over a significant radial distance. Thus, the orientation, in particular the angle towards the axis of rotation, of the coolant jet can be adjusted over a broad range.

According to one aspect of the invention, the difference between the first radial distance and the second radial distance is at least 0.02 mm, in particular at least 1 mm. In addition to or alternatively, the difference between the first radial distance and the second radial distance is at most 5 mm, in particular at most 1 mm. Thus, a suitable range of cutting speeds and tool lengths is covered.

In another embodiment of the invention, a coolant channel portion adjacent to the opening extends at a first angle with respect to the axis of rotation in the first position and at a second angle with respect to the axis of rotation in the second position, the difference between the first angle and the second angle being at least 4 degrees. The coolant channel portion adjacent to the opening defines the direction of the coolant exiting through the opening. Therefore, a difference of at least 4 degrees between the first angle and the second angle provides a broad range of coolant jet directions.

In a further embodiment of the invention, the tool holder has a plurality of coolant channels, each extending through its own protrusion. Thus, a plurality of coolant jets are provided during operation to improve the cooling capability. Further, with a plurality of coolant jets, multiple different areas of the rotary cutting tool can be cooled simultaneously, in particular if the angle with respect to the axis of rotation differs between the coolant jets or the coolant channel portions adjacent to the opening.

According to another aspect of the invention, the protrusions are circumferentially spaced from one another around the holder, in particular equally, i.e. the distance between two neighboring protrusions is equal in each case. In this way, the cooling efficiency can be increased.

According to a further embodiment of the invention, the adjusting mechanism has a sleeve-shaped adjusting element which is arranged in the first position in a first axial position and in the second position in a second axial position relative to the body, the adjusting element in the first and second position pushing the axial protrusions radially inwards by radially different amounts, preferably with the axial adjustment continuously changing the radial deflection of the axial protrusions. Thus, the adjusting mechanism is designed in a simple and compact way and such that all axial protrusions can be adjusted by the adjusting element at the same time.

In another embodiment of the invention, the adjusting mechanism comprises a locking mechanism which locks the adjusting element in a selected position, e.g. the first position or the second position, to securely hold the adjusting element in place during operation.

In one embodiment of the invention, the difference between the first axial position and the second axial position is between 0.5 and 7 mm, which provides a sufficient range to adapt the orientation of the coolant jets over a broad range.

According to another aspect of the invention, the adjusting element has an inside adjusting surface which in the first and second position abuts against an outside adjusting surface of the axial protrusion, the inside adjusting surface and/or the outside adjusting surface extending at an angle with respect to the axis of rotation which is between 2 and 45 degrees. This design has the advantage that the axial protrusions can be elastically deflected in an effective way.

In a further embodiment of the invention the inside adjusting surface and/or the outside adjusting surface each has an axial length which is between 15 and 35% of the axial length of the protrusion and thus covers a sufficient length to effectively deflect the protrusion.

Any individual feature of any of the embodiments disclosed above may be part of any of the embodiments disclosed above thus forming a further embodiment of the invention. In other words, any or all of the individual features disclosed above can be combined in a further embodiment of the invention.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a tool holder according to the invention in an exploded view;

FIG. 2 schematically shows the tool holder of FIG. 1 in a sectional view;

FIG. 3 schematically shows detail B of FIG. 2 with an adjusting mechanism of the tool holder in a first position; and

FIG. 4 schematically shows detail B of FIG. 2 with the adjusting mechanism in a second position.

### DETAILED DESCRIPTION

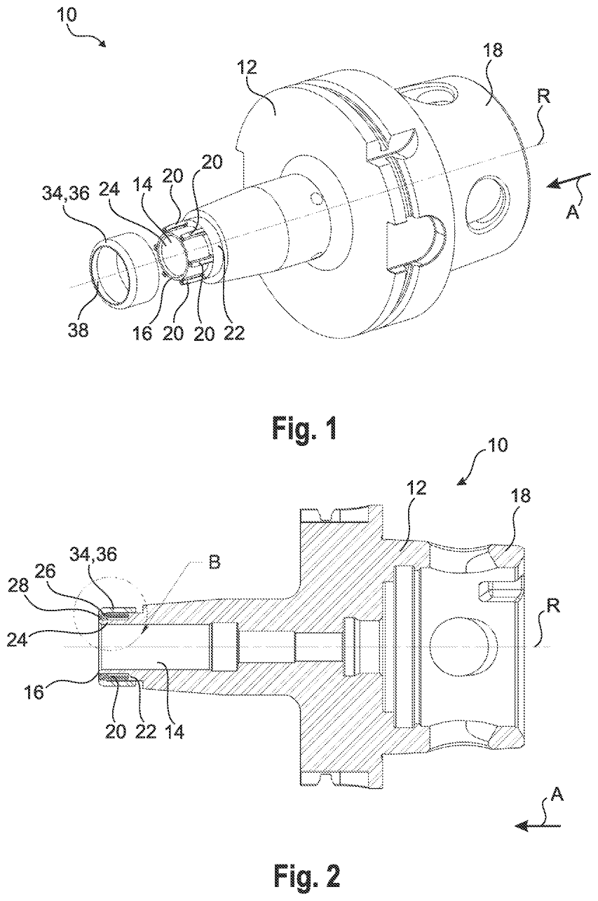

FIG. 1 schematically shows a tool holder 10 comprising a body 12 and a receptacle 14 for a rotary cutting tool (not shown).

The tool holder 10 is made of tool steel.

In one embodiment, the tool holder 10 is a shrink fit or a hydraulic chuck.

The receptacle 14 (see FIG. 2) extends from a front face 16 of the body 12 coaxially to an axis of rotation R towards a rear end 18 of the body 12, the rear end 18 forming a coupling portion for coupling the tool holder 10 to a machine spindle.

The tool holder 10 further comprises multiple finger-like protrusions 20 extending in axial direction A from a shoulder 22 of the body 12 to the front face 16.

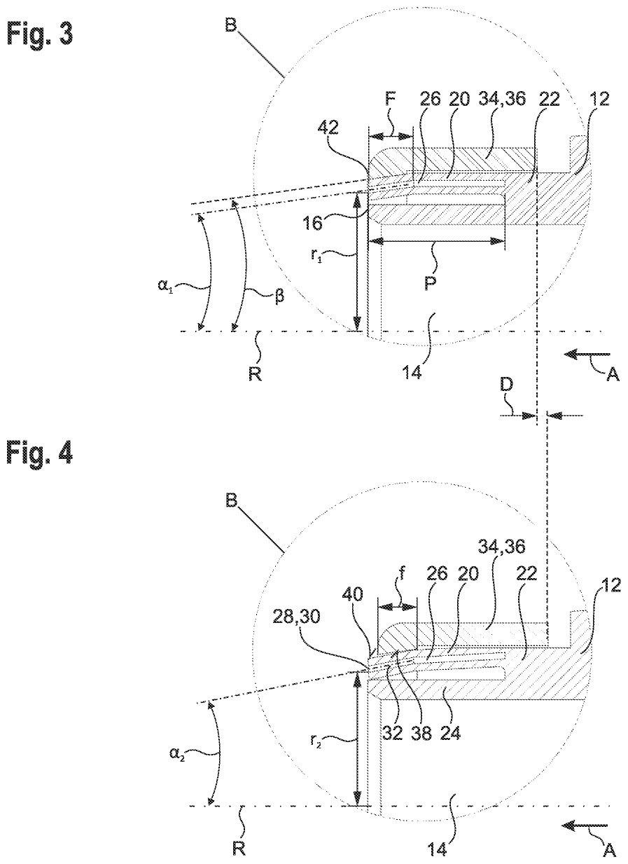

The axial length P (see FIG. 3) of the protrusions 20 is at least 4 mm.

In an alternative embodiment, the axial length P of the protrusions 20 is at least 9 mm.

In the embodiment shown, the tool holder 10 comprises six protrusions 20.

In an alternative embodiment, the tool holder 10 can comprise any number of protrusions 20, in particular between one and twelve.

The protrusions 20 are arranged circumferentially around the receptacle 14 and are radially spaced from a section 24 of the body 12 surrounding the receptacle 14 at the front face 16.

Further, the protrusions 20 may be equally spaced from one another as shown in FIG. 1.

In the embodiment shown, the protrusions 20 are a monolithic part of the body 12.

In an alternative embodiment, the body 12 and at least one of the protrusions 20 can be formed by separate parts.

The body 12 and/or the protrusions 20 can be manufactured by additive manufacturing like 3D printing.

The protrusions 20 each comprise an internal coolant channel 26 (see FIG. 4) extending from an opening 28 at the distal end 30 of the protrusion 20 into the body 12 and being fluidly connected to a coolant supply (not shown in the Figures).

Please note that this means that the coolant channels 26 do not end at the shoulder 22 as shown in the Figures which merely show a schematic representation of the tool holder 10.

The portion 32 (see FIG. 3) of the coolant channel 26 ending in the opening 28 forms a nozzle through which coolant is sprayed to a section of the rotary cutting tool in the form of a coolant jet during operation of the tool holder 10.

In the embodiment shown, the protrusions 20 are formed identically.

However, in an alternative embodiment, the protrusions 20 and/or the respective coolant channels 26 can be formed individually, in particular to provide nozzles with different orientation, i.e. nozzles that are directed to different axial sections of the rotary cutting tool.

For adjusting the orientation of the nozzles, the tool holder 10 comprises an adjusting mechanism 34 which is adjustable between a first position (see FIG. 3) and a second position (see FIG. 4).

The adjusting mechanism 34 has a sleeve-like adjusting element 36 which in the first position is arranged in a first axial position relative to the body 12 and in the second position is arranged in a second axial position relative to the body 12.

The difference D between the first axial position and the second axial position is 3 mm.

In an alternative embodiment, the difference D between the first axial position and the second axial position is between 0.5 and 7 mm.

The sleeve-like adjusting element 36 may be a locknut which is coupled to the body 12 via a thread in order to ensure a stable position.

For example, the shoulder 22 may comprise an external thread and the adjusting element 36 a corresponding internal thread.

However, other means of a locking mechanism with the same effect are equally viable.

In an alternative embodiment, in particular in which the tool holder 10 only comprises a single protrusion 20 or a few protrusions 20, the adjusting mechanism 34 and/or the adjusting element 36 can be designed differently as long as the adjusting mechanism 34 shares the following functionality with the embodiment presented here.

The adjusting element 36 is designed to elastically deflect the protrusions 20 radially inward, i.e. towards the axis of rotation R, when the adjusting element 36 is moved against axial direction A towards shoulder 22.

To this effect the adjusting element 36 has an inside adjusting surface 38 and the axial protrusions 20 each have a corresponding outside adjusting surface 40 which abut against each other between the first position and the second position.

The outside adjusting surfaces 40 extend from the distal ends 30 and have an axial length F which is between 15 and 35% of the axial length P of the protrusions 20.

The inside adjusting surface 38 extends from a front end 42 of the adjusting element 36 and has an axial length f which is between 15 and 35% of the axial length P of the protrusions 20.

In the embodiment shown, the inside adjusting surface 38 and the outside adjusting surfaces 40 are formed by a chamfer extending at an angle ß of 10 degrees with respect to the axis of rotation R.

In an alternative embodiment, the inside adjusting surface 38 and/or the outside adjusting surfaces 40 extend at an angle ß of between 2 and 45 degrees with respect to the axis of rotation R.

In particular, in an alternative embodiment, the inside adjusting surface 38 and the outside adjusting surfaces 40 may be designed differently from each other. For example, the inside adjusting surface 38 and the outside adjusting surfaces 40 may comprise chamfers with different angles β. In addition to or alternatively, the inside adjusting surface 38 and/or the outside adjusting surfaces 40 may be designed without a chamfer.

In the first position the openings 28 are at a first radial distance r₁ from the axis of rotation R and in the second position the openings 28 are at a second radial distance r₂ from the axis of rotation R, the second radial distance r₂ being shorter than the first radial distance r₁.

The difference between the first radial distance r₁ and the second radial distance r₂ can be at least 0.02 mm, in particular at least 1 mm.

Further, the difference between the first radial distance r₁ and the second radial distance r₂ can be at most 5 mm, in particular at most 1 mm.

In the first position, the coolant channel portions 32 extend at a first angle α₁ with respect to the axis of rotation R. In the second position, the coolant channel portions 32 extend and at a second angle α₂ with respect to the axis of rotation R.

The first angle α₁ and/or the second angle α₂ may each be between 2 and 45 degrees.

In one embodiment, the difference between the first angle α₁ and the second angle α₂ is between 0.1 and 15 degrees.

In another embodiment, the difference between the first angle α₁ and the second angle α₂ is at least 4 degrees.

In the embodiment presented here, the adjusting element 36 elastically deflects the protrusions 20 radially inwards by radial amounts which continuously increase when the adjusting element 36 is moved from the first position to the second position.

Thus, the angle of the coolant channel portions 32 continuously decreases from angle α₁ to angle α₂ when the adjusting element 36 is moved from the first position to the second position.

In this way, a tool holder 10 for rotary cutting tools is provided whose adjusting mechanism 34 allows to adapt the direction of the nozzles to supply coolant to the rotary cutting tool over a wide range of cutting speeds and tool lengths in an effective way.

1. Tool holder for rotary cutting tools, comprising an axis of rotation, a body having a receptacle for the rotary cutting tool, the receptacle extending coaxially with the axis of rotation, and at least one coolant channel terminating in an opening and adapted to conduct coolant to the rotary cutting tool via the opening, wherein the coolant channel extends through an axial protrusion and the tool holder has an adjusting mechanism which is adjustable between a first position, in which the opening is at a first radial distance from the axis of rotation, and a second position, in which the opening is at a second, different radial distance from the axis of rotation, the axial protrusion being elastically deflected in the second position relative to the first position by the adjusting mechanism.

2. Tool holder according to claim 1, wherein the protrusion has an axial length of at least 4 mm, in particular of at least 9 mm.

3. Tool holder according to claim 1, wherein the difference between the first radial distance and the second radial distance is at least 0.02 mm, in particular at least 1 mm, and/or at most 5 mm, in particular at most 1 mm.

4. Tool holder according to claim 2, wherein the difference between the first radial distance and the second radial distance is at least 0.02 mm, in particular at least 1 mm, and/or at most 5 mm, in particular at most 1 mm.

5. Tool holder according to claim 1, wherein a coolant channel portion adjacent to the opening extends at a first angle with respect to the axis of rotation in the first position and at a second angle with respect to the axis of rotation in the second position, the difference between the first angle and the second angle being at least 4 degrees.

6. Tool holder according to claim 2, wherein a coolant channel portion adjacent to the opening extends at a first angle with respect to the axis of rotation in the first position and at a second angle with respect to the axis of rotation in the second position, the difference between the first angle and the second angle being at least 4 degrees.

7. Tool holder according to claim 3, wherein a coolant channel portion adjacent to the opening extends at a first angle with respect to the axis of rotation in the first position and at a second angle with respect to the axis of rotation in the second position, the difference between the first angle and the second angle being at least 4 degrees.

8. Tool holder according to claim 4, wherein a coolant channel portion adjacent to the opening extends at a first angle with respect to the axis of rotation in the first position and at a second angle with respect to the axis of rotation in the second position, the difference between the first angle and the second angle being at least 4 degrees.

9. Tool holder according to claim 1, wherein the tool holder has a plurality of coolant channels, each extending through its own protrusion.

10. Tool holder according to claim 2, wherein the tool holder has a plurality of coolant channels, each extending through its own protrusion.

11. Tool holder according to claim 9, wherein the protrusions are circumferentially spaced from one another around the holder, in particular equally.

12. Tool holder according to claim 10, wherein the protrusions are circumferentially spaced from one another around the holder, in particular equally.

13. Tool holder according to claim 1, wherein the adjusting mechanism has a sleeve-shaped adjusting element which is arranged in the first position in a first axial position and in the second position in a second axial position relative to the body, the adjusting element in the first and second position pushing the axial protrusions radially inwards by radially different amounts, preferably with the axial adjustment continuously changing the radial deflection of the axial protrusions.

14. Tool holder according to claim 2, wherein the adjusting mechanism has a sleeve-shaped adjusting element which is arranged in the first position in a first axial position and in the second position in a second axial position relative to the body, the adjusting element in the first and second position pushing the axial protrusions radially inwards by radially different amounts, preferably with the axial adjustment continuously changing the radial deflection of the axial protrusions.

15. Tool holder according to claim 13, wherein the difference between the first axial position and the second axial position is between 0.5 and 7 mm.

16. Tool holder according to claim 14, wherein the difference between the first axial position and the second axial position is between 0.5 and 7 mm.

17. Tool holder according to claim 13, wherein the adjusting element has an inside adjusting surface which in the first and second position abuts against an outside adjusting surface of the axial protrusion, the inside adjusting surface and/or the outside adjusting surface extending at an angle with respect to the axis of rotation which is between 2 and 45 degrees.

18. Tool holder according to claim 15, wherein the adjusting element has an inside adjusting surface which in the first and second position abuts against an outside adjusting surface of the axial protrusion, the inside adjusting surface and/or the outside adjusting surface extending at an angle with respect to the axis of rotation which is between 2 and 45 degrees.

19. Tool holder according to claim 17, wherein the inside adjusting surface and/or the outside adjusting surface each has an axial length which is between 15 and 35% of the axial length of the protrusion.

20. Tool holder according to claim 18, wherein the inside adjusting surface and/or the outside adjusting surface each has an axial length which is between 15 and 35% of the axial length of the protrusion.
